(19) United States
(12) Patent Application Publication
(10) Pub. No.: US 2021/0314438 A1
(43) Pub. Date: Oct. 7, 2021

(54) CONTENT DISTRIBUTION SYSTEMS AND METHODS

(71) Applicant: RingADring Ltd., Bat Yam (IL)

(72) Inventors: Itzhak HORESH, Bat Yam (IL); Teddy LAZEBNIK, Ramat Gan (IL)

(21) Appl. No.: 16/327,862

(22) PCT Filed: Sep. 13, 2017
(86) PCT No.: PCT/IB2017/055525

§ 371 Date: Feb. 25, 2019

Related U.S. Application Data
(60) Provisional application No. 62/394,250, filed on Sep. 14, 2016.

(51) Int. Cl. H04M 3/42

(52) U.S. Cl. CPC H04M 3/42051; H04M 2203/558; H04M 3/42068; H04M 3/42017

(57) ABSTRACT

A system comprising: (a) a server receiving a calling party's phone number and a called party's phone number when a telephone call is placed; (b) a database of content items uploaded to the server, each of said content items associated with a telephone number of a party that uploaded it; and (c) a content delivery mechanism configured to push a unique identifier (UID) of a specific content item uploaded by the called party to the calling party's handset in response to said receiving by said server.

### RELATED APPLICATIONS

This application claims the benefit under 35 U.S.C. § 119(e) of provisional application U.S. 62/394,250 filed 14 Sep. 2016 and having the same title and inventors as the instant application; which is fully incorporated herein by reference.

### FIELD OF THE INVENTION

The invention is in the field of content distribution.

### BACKGROUND OF THE INVENTION

Historically dissemination of content was difficult. Printed books required the creator of the written content to hire a printer and/or publisher.

The development of recording technology made dissemination of sound based content feasible, but the creator of the sound content was still dependent upon a recording company and/or a music publisher/distributor.

Radio, and later television, opened channels of transient content distribution. Initially if you did not listen to/watch a broadcast, the content was unavailable.

The Internet caused an explosion in content distribution. It also empowered content creators to disseminate content independently.

Smartphones have proven to be another platform for content distribution in the form of ringtones and wallpapers.

### SUMMARY OF THE INVENTION

A broad aspect of the invention relates to targeted content delivery by individuals. According to various exemplary embodiments of the invention the content being delivered includes audio and/or graphics and/or video and/or an applet.

One aspect of some embodiments of the invention relates to push of a ring-back tone while a call is being connected. These embodiments include presentation of content selected by a called party on a smart device of a calling party while the calling party is waiting for the call to be connected to the called party. In some exemplary embodiments of the invention, the content transfer is mediated by a remote server. Alternatively or additionally, in some embodiments the content selected by a called party is stored in advance on a server and retrieved by the calling party from the server using a unique identifier transmitted from the called party. In some embodiments the unique identifier is delivered with an applet that automatically downloads the content from the server based on the unique identifier.

According to another aspect of some embodiments of the invention a server receives a content item from a subscriber and links the content items to a telephone number of the subscriber in a database. In some embodiments a distribution mechanism of the server pushes the content item to a handset operated by a party calling the subscriber before the call is connected. In some exemplary embodiments of the invention, the distribution mechanism selects from a content item from many content items provided by the relevant subscriber according to distribution rules.

According to another aspect of some embodiments of the invention a server receives a content item from a first subscriber and links the content items to a telephone number of the subscriber in a database then pushes the content items linked with subscriber phone numbers to handsets of other subscribers (For example, subscribers in the contact list of the first subscriber) according to distribution rules. In some embodiments the pushed content items are unavailable to the owner of the handset until one of the other subscribers places a call to the first subscriber. Placement of the call unlocks the content item stored on the handset from which the call originated.

According to another aspect of some embodiments of the invention a handset of a subscriber receives and stores multiple content items pushed to it from a server. In some embodiments each content item is associated with a telephone number of a subscriber that uploaded it. In some embodiments an outgoing call from the subscriber causes presentation of a stored content item associated with the telephone number being called.

According to another aspect of some embodiments of the invention a calling party pushes a ringtone to a called party. According to these embodiments, the calling party transmits content to a called party concurrent with a phone call from the calling party to the called party. In some embodiments the content is presented on a handset of the called party before the call is connected. In some embodiments connection of the call cuts off the content.

For purposes of this specification and the accompanying claims, the term “ringtone” indicates content presented on a telephone handset (e.g. smartphone, phablet tablet or computer) to indicate an incoming call.

For purposes of this specification and the accompanying claims, the term “ring-back tone” indicates content presented on a telephone handset (e.g. smartphone, phablet or tablet) while an outgoing call is in the process of being connected.

For purposes of this specification and the accompanying claims, the term “content” includes audio and/or graphics and/or video and/or an applet.

For purposes of this specification and the accompanying claims, the term “download” includes streaming.

It will be appreciated that the various aspects described above relate to solution of technical problems associated with targeting of content.

Alternatively or additionally, it will be appreciated that the various aspects described above relate to solution of technical problems related to creation of new content presentation platforms.

In some exemplary embodiments of the invention there is provided a system including: (a) a server receiving a calling party's phone number and a called party's phone number when a telephone call is placed; (b) a database of content items uploaded to the server, each of the content items associated with a telephone number of a party that uploaded it; and (c) a content delivery mechanism configured to push a unique identifier (UID) of a specific content item uploaded by the called party to the calling party's handset in response to the receiving by the server. In some embodiments the content delivery mechanism resides on the server. Alternatively or additionally, in some embodiments the server is not operated by a service provider handling the telephone call which is placed. Alternatively or additionally, in some embodiments the database resides in a cloud server. Alternatively or additionally, in some embodiments the content delivery mechanism pushes an applet to the calling party's handset, the applet causing automatic download and presentation of the specific content item. Alternatively or additionally, in some embodiments an elapsed time between placement of the call by the calling party and onset of presentation of the specific content item on the calling party's handset is less than 2 seconds.

In some exemplary embodiments of the invention there is provided a system including: (a) a server receiving requests to deliver a specific content item to a calling party's handset, each request originating from a handset of a called party; (b) a database of content items uploaded to the server, each of the content items associated with a telephone number of a party that uploaded it; and (c) a content delivery mechanism configured to push a unique identifier (UID) of a specific content item from the server to the calling party's handset in response to the request originating from a handset of a called party. In some embodiments the system includes a rules engine governing distribution of content items in the database according to predetermined rules. Alternatively or additionally, in some embodiments the predetermined rules are provided as part of each of the content items uploaded to the server. Alternatively or additionally, in some embodiments the predetermined rules are provided as part the content delivery mechanism. Alternatively or additionally, in some embodiments the system includes a profile database of people associated with specific phone numbers, wherein data from the profiles is available to the rules engine. Alternatively or additionally, in some embodiments the server is not operated by a service provider handling telephone calls. Alternatively or additionally, in some embodiments the database resides in a cloud server.

In some exemplary embodiments of the invention there is provided a system including: (a) a database of content items uploaded to a server, each of the content items associated with a telephone number of a party that uploaded it; and (b) a distribution mechanism that distributes each of the content items associated with a telephone number of a party that uploaded it to a plurality of handsets belonging to other parties. In some embodiments the system includes a rules engine governing distribution of content items by the distribution mechanism according to predetermined rules. Alternatively or additionally, in some embodiments the predetermined rules are provided as part of each of the content items uploaded to the server. Alternatively or additionally, in some embodiments the system includes a profile database of people associated with specific phone numbers, wherein data from the profiles is available to the rules engine. Alternatively or additionally, in some embodiments the system includes a content locking module configured to lock each of the content items associated with a telephone number of a party that uploaded it item so the locked content item is accessible only in response to an incoming call from a telephone number of a party that uploaded it.

In some exemplary embodiments of the invention there is provided a system including: (a) a server receiving calling party's phone number and called party's phone number; and (b) a content delivery mechanism that pushes a unique identifier (UID) of a content item from the called party to the calling party's phone. In some embodiments the system includes a rules engine governing the content delivery mechanism according to predetermined rules.

In some embodiments the system includes a content unlocking module configured to associate a called party's phone number with the UID pushed by the content distribution mechanism.

In some exemplary embodiments of the invention there is provided a system including: (a) a telephone handset storing at least one content item in a memory; and (b) a call monitoring module that detects an outgoing call and sends at least one of the at least one content items to the number being called via a data connection. Alternatively or additionally, in some embodiments the at least one content item is stored as a pointer to a remote memory location. Alternatively or additionally, in some embodiments the at least one content item is formatted as a ringtone.

In some exemplary embodiments of the invention, there is provided a method including: (a) defining one or more content items as ring-back tones via a user interface of a telephone handset; (b) establishing rules for ring-back tone push via the user interface; and (c) pushing the ring-back tone to a handset of a calling party via a data channel when an incoming call is received on a voice channel. In some embodiments at least some of the one or more content items include visual information.

In some exemplary embodiments of the invention there is provided a method including: (a) defining one or more content items as ring tones via a user interface of a telephone handset; (b) establishing rules for ring tone push via the user interface; and (c) pushing the ring tone to a handset of a called party via a data channel when an outgoing call by a push module of the telephone handset. In some embodiments at least some of the one or more content items include visual information.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and/or system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a simplified system overview illustrating the operational context of various exemplary embodiments of the invention;

FIG. 2 is a schematic diagram of a system according to some exemplary embodiments of the invention;

FIG. 3 is a schematic diagram of a system according to some exemplary embodiments of the invention;

FIG. 4 is a schematic diagram of a system according to some exemplary embodiments of the invention;

FIG. 5 is a schematic diagram of a system according to some exemplary embodiments of the invention;

FIG. 6 is a schematic diagram of a system according to some exemplary embodiments of the invention;

FIG. 7 is a simplified flow diagram of a method according to some exemplary embodiments of the invention; and

FIG. 8 is a simplified flow diagram of a method according to some exemplary embodiments of the invention.

### DETAILED DESCRIPTION OF EMBODIMENTS

The principles and operation of a system and/or method according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Embodiments of the invention relate to presentation of content on a telephone handset. For purposes of this specification and the accompanying claims, the term “telephone handset” includes any device capable of placing a telephone call. For purposes of this specification and the accompanying claims, the term “telephone call” indicates any transmission of a voice signal via a cellular network, VOIP or VOIP transmitted via cellular data service along at least a portion of its route.

In some embodiments ring-back content is selected by a called party and presented by a new protocol named Over IP (Internet Protocol) Ring Back Content (OIPRBC). This protocol makes presentation of visual content as part of “ring-back” possible for the first time. Addition of visual content is a significant improvement relative to conventional ring-back tones which are limited to audio. Alternatively or additionally, allowing a called party to set their own ring-back content is a significant departure from conventional practice in which the telephone service provider has exclusive control over ring-back tones.

In some embodiments ringtone content is selected by a calling party for presentation to a called party by a new protocol named Over IP (Internet Protocol) Ring Tone Content (OIPRTC). This protocol makes presentation of visual content as part of “ringtone” possible for the first time. Addition of visual content is a significant improvement relative to conventional ring tones which are limited to audio. Alternatively or additionally, allowing a calling party to set their own ringtone is a significant departure from conventional practice in which the called party has exclusive control over ringtones.

Specifically, some embodiments of the invention can be used to present content on a handset while a call is in the process of being connected. According to various exemplary embodiments of the invention content presentation is on the called party's handset and/or on the calling party's handset.

System Overview

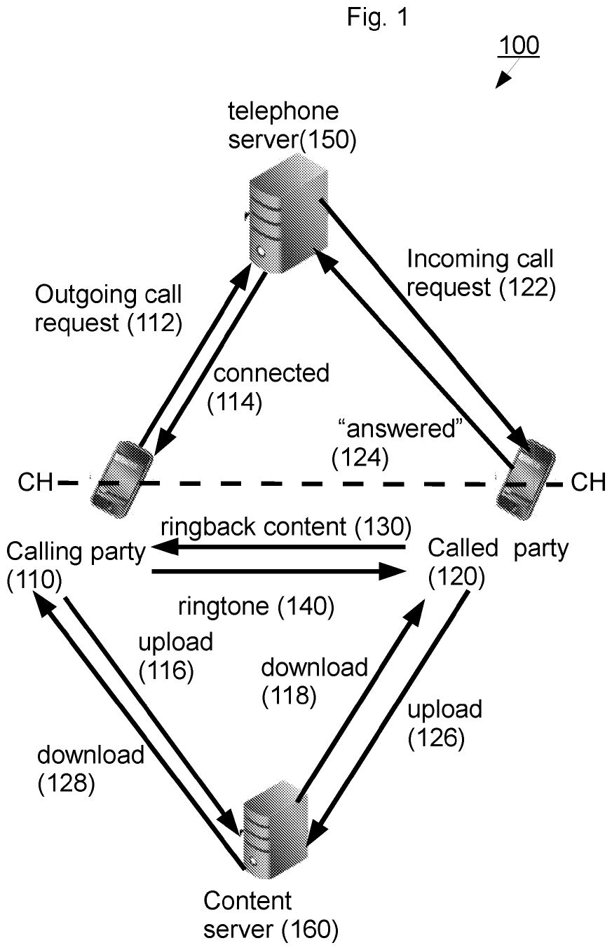

FIG. 1 is a simplified system overview, indicated generally as 100, illustrating the operational context of various exemplary embodiments of the invention. Line CH-CH indicates the separation between voice channel (above the line) and data channel (below the line) for a conventional cellular telephone call. For video calls and/or VOW calls. The call itself is transmitted on a data channel, but the flow of data is similar.

FIG. 1 depicts a single calling party 110 and a single called party 120 for clarity of illustration, although a much larger number will be present in actual practice. “The word “party” is used to indicate the person holding the handset because the people view and/or hear presented content. However, the various functions described are performed exclusively by the handsets and/or servers. Alternatively or additionally, a single handset functions sometimes as a calling party and sometimes as a called party. In some embodiments handsets of calling party 110 and/or calling party 120 are configured with a software application that allows them to realize various features described hereinbelow.

In the depicted embodiment, calling party 110 places an outgoing call request 112 via a telephone server 150. Request 112 is routed to called party 120 as incoming call request 122. The incoming request 122 is either refused or answered 124 by called party 120. In case the call is answered server 150 connects 114 the call to calling party 110.

Some exemplary embodiments of the invention are based on the fact that the delay between outgoing call request 112 and connection 114 is significant. In the cellular telephone systems tested the average duration of delay was on 2.8 seconds for 20 MB network and 1.1 sec for 100 MB network. The distance between the devices has a negligible effect on the delay.

According to these embodiments, called party 120 pushes ring-back content 130 to the handset of calling party 110.

Alternatively or additionally, in some embodiments calling party 110 pushes ringtone content 140 to called party 120.

In some embodiments pushes content 130 and/or 140 involve direct transfer of the data file for the content between handsets 110 and 120 (in either direction). Alternatively or additionally, in some embodiments pushing of content is mediated by a content server 160.

In some embodiments calling party 110 and/or called party 120 upload content items (116 and 126 respectively) to server 160 for subsequent download 118 and 128 by called party and calling party respectively. According to various exemplary embodiments of the invention uploads (116 and/or 118) and/or downloads (126 and/or 128) are conducted in advance and/or in response to a specific call being placed.

In embodiments in which content server 160 is used for content transfer, content 130 and/or 140 is transmitted from handset to handset as a unique identifier (UID) for a content item. In some embodiments receipt of the UID at a receiving handset triggers download (126 or 128) and presentation of the content item specified by the UID.

In some embodiments owners of handsets (e.g. 110 and/or 120) subscribe to receive services provided via server 160. According to various exemplary embodiments of the invention subscription includes installation of software on the handset and/or sharing of a phone numbers and/or group tags from a contacts list with server 160 and/or provision of a user profile to server 160.

First Exemplary System

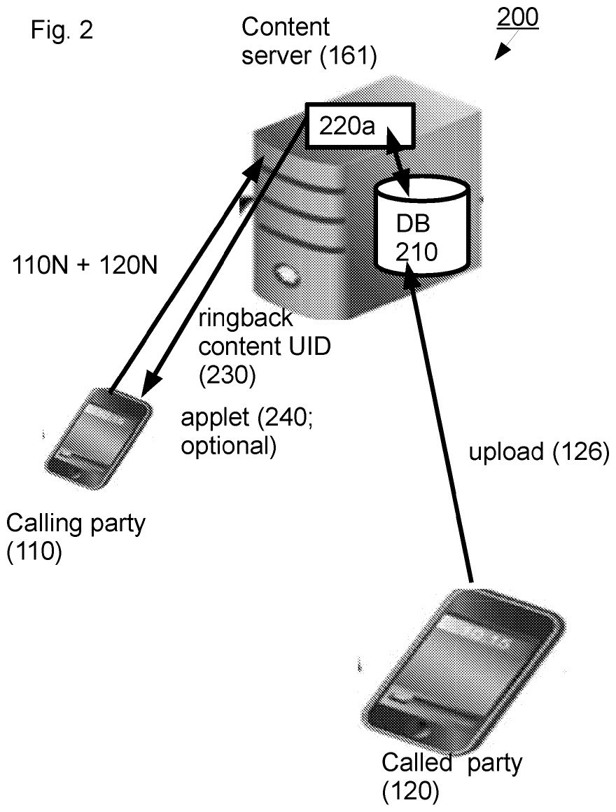

FIG. 2 is a schematic diagram of a system for providing ring-back content determined by a called party according to some exemplary embodiments of the invention indicated generally as 200.

Depicted exemplary system 200 includes a server 161 receiving a calling party's 110 phone number 110N and a called party's 120 phone number 120 when a telephone call is placed by the calling party's handset. In the depicted embodiment, a database 210 of content items uploaded to server 161 contains content items, each content item being associated with a telephone number of a party that uploaded it. In some embodiments database 210 resides in a cloud server.

Depicted exemplary system 200 also includes a content delivery mechanism 220a configured to push a unique identifier (UID) 230 of a specific content item uploaded to DB 210 by the called party to the calling party's handset 110 in response to receipt of 110N and 120N by server 161.

According to various exemplary embodiments of the invention the UID is a location in a local directory of calling party's handset 110 or a location in a remote directory (e.g. in DB 210). In some embodiments the UID is formatted as a phone number of a party that uploaded it plus a time/date stamp. In the depicted embodiment, content delivery mechanism 220a resides on server 161. In other exemplary embodiments of the invention, the content delivery mechanism resides on handset 120 belonging to the called party. In some embodiments server 161 is not operated by a service provider handling the telephone call from 110 to 120.

In some embodiments content delivery mechanism 220a pushes an applet 240 to the calling party's handset 110. Applet 240 causes automatic download and presentation of the specific content item indicated by UID 230. In other exemplary embodiments of the invention, software causing automatic download and presentation of the specific content item indicated by UID 230 is resident on handset 110.

In some embodiments an elapsed time between placement of the call by calling party 110 and onset of presentation of the specific content item indicated by UID 230 on said calling party's handset is less than 2 seconds, less than 1 second or less than 0.75 seconds or intermediate or shorter times. In contrast, for a called party aged 18 to 35 the average time for answering the phone is 8.66 seconds. For a called party aged 35 to 55 the average time for answering the phone is 12.33 seconds. This means that there are several seconds available for content presentation before the call is connected.

Second Exemplary System

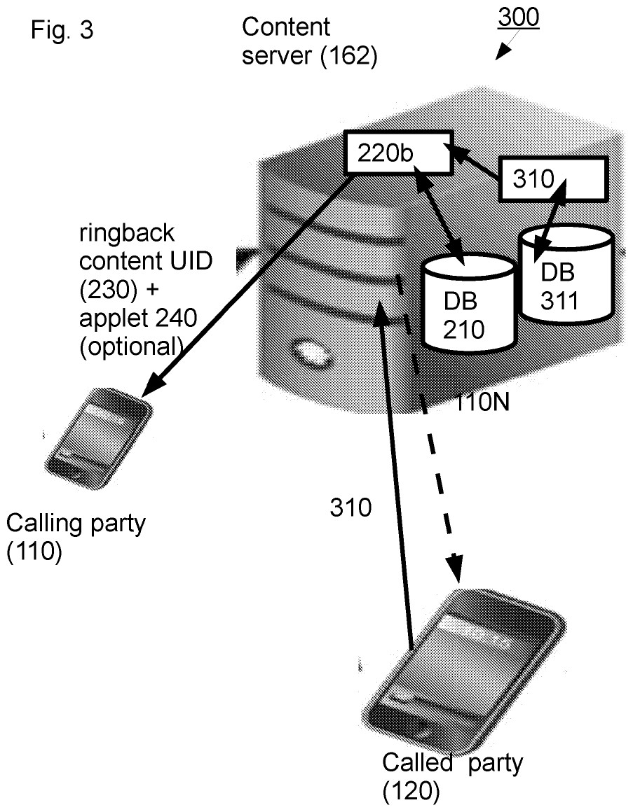

FIG. 3 is a schematic diagram of a system according to some exemplary embodiments of the invention in which the called party's handset makes requests for ring-back tone content delivery to the calling party's handset indicted generally as 300.

Depicted exemplary system 300 includes a server 162 receiving requests 310 to deliver a specific content item to a calling party's handset 110, each request originating from a handset of a called party 120. In some exemplary embodiments of the invention, each request 310 is in response to receipt of telephone number 110N of handset 110 via a data channel.

In the depicted embodiment, system 300 includes a database 210 of content items uploaded to server 162 with each content item associated with a telephone number of a party that uploaded it. In the depicted embodiment, system 300 also includes a content delivery mechanism 220b configured to push a unique identifier (UID) 230 of a specific content item from server 162 to the calling party's handset 110 in response to request 310 originating from handset 120 of the called party.

In the depicted embodiment, system 300 includes a rules engine 310 governing distribution of content items in database 210 according to predetermined rules. In some embodiments predetermined rules are provided as part of each of the content items uploaded to the server. For example, in some embodiments a content item is tagged for distribution only on weekends if its appearance on a screen or speakers of handset 110 in the workplace might be problematic. Alternatively or additionally, in some embodiments a content item is tagged for distribution only to telephone numbers residing in the contacts list of handset 120, or to certain groups within that contacts list.

Alternatively or additionally, in some embodiments predetermined rules are provided as part of content delivery mechanism 220b.

In some embodiments system 300 includes a profile database 311 of people associated with specific phone numbers. According to these embodiments data from the profiles in database 311 is available to rules engine 310.

In some embodiments server 162 is not operated by a service provider handling the telephone call from 110 to 120. Alternatively or additionally, in some embodiments databases 210 and/or 311 reside in a cloud server.

Third Exemplary System

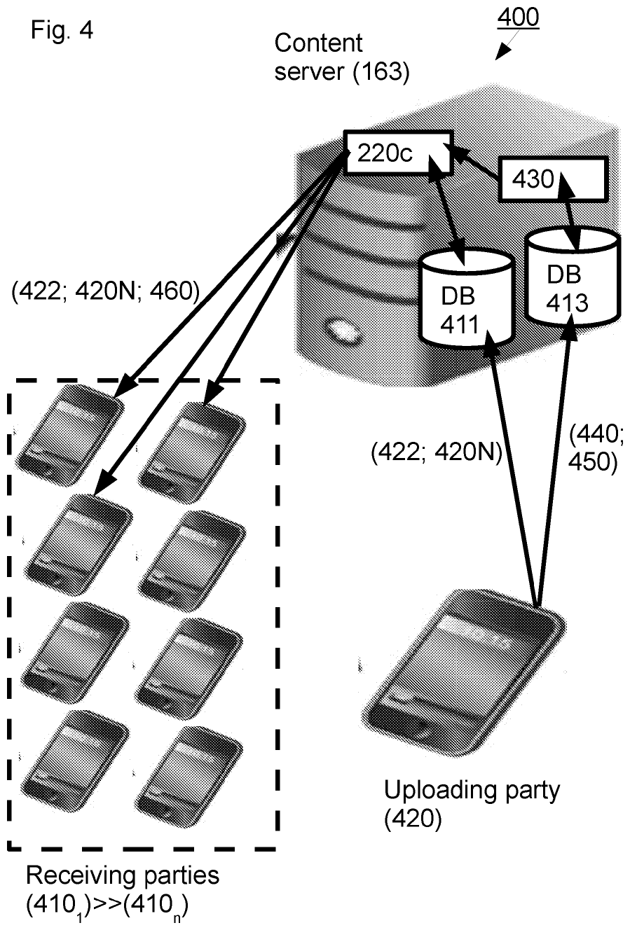

FIG. 4 is a schematic diagram of a system for pre-distribution of content according to some exemplary embodiments of the invention indicated generally as system 400.

Depicted exemplary system 400 includes a database 411 of content items 422 uploaded to a server 163. Each of content items 422 is associated with a telephone number 420N of a party 420 that uploaded it.

Depicted exemplary system 400 also includes a distribution mechanism 220c that distributes each of content items 422 associated with telephone number 420N of a party 420 that uploaded it to a plurality of handsets 410₁ to 410ₙ belonging to other parties.

In the depicted embodiment, system 400 includes a rules engine 430 governing distribution of content items 422 by distribution mechanism 220c according to predetermined rules. In some embodiments predetermined rules are provided as part of each of content item 422 uploaded to server 163.

Depicted exemplary system 400 includes a profile database 413 of people associated with specific phone numbers. In embodiments including database 413, data from the profiles is available to rules engine 430.

In some exemplary embodiments of the invention, system 400 includes a content locking module 460 configured to lock each of content items 422 associated with telephone number 420N of the party that uploaded the item so the locked content item is accessible only in response to an incoming call from telephone number 420N. Locking module 460 is depicted as an applet distributed with content item 422.

Fourth Exemplary System

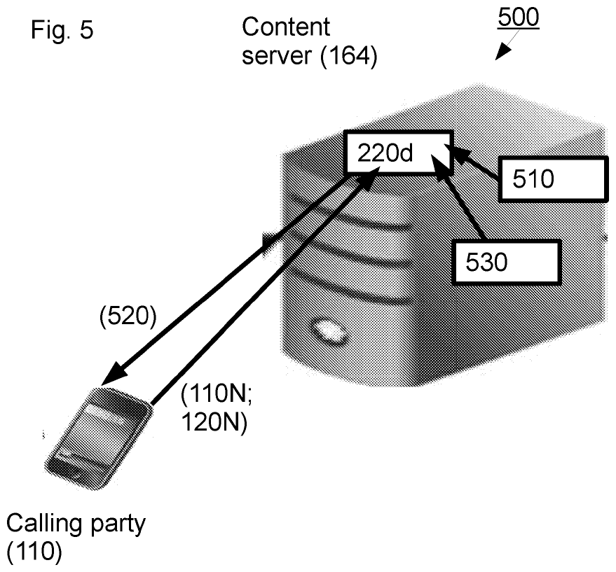

FIG. 5 is a schematic diagram of a system for unlocking content stored on smartphones in response to incoming call according to some exemplary embodiments of the invention indicated. System 500 works in conjunction with system 400 or a functionally similar system.

Depicted exemplary system 500 includes a server 164 receiving calling party's phone number 110N and called party's phone number 120N and a content delivery mechanism 220d that pushes a unique identifier (UID) 520 of a content item from the called party (not depicted in this figure) to the calling party's phone 110. According to these embodiments, the content items themselves are already stored at 110 (see 422 pushed to receiving parties 410 in FIG. 4).

In some embodiments system 500 includes a rules engine 510 governing content delivery mechanism 220d according to predetermined rules. In other exemplary embodiments of the invention, the rules engine resides on a called party's phone.

In some embodiments system 500 includes a content unlocking module 530 configured to associate a called party's phone number 120N with UID 520 pushed by content distribution mechanism 220d.

Fifth Exemplary System

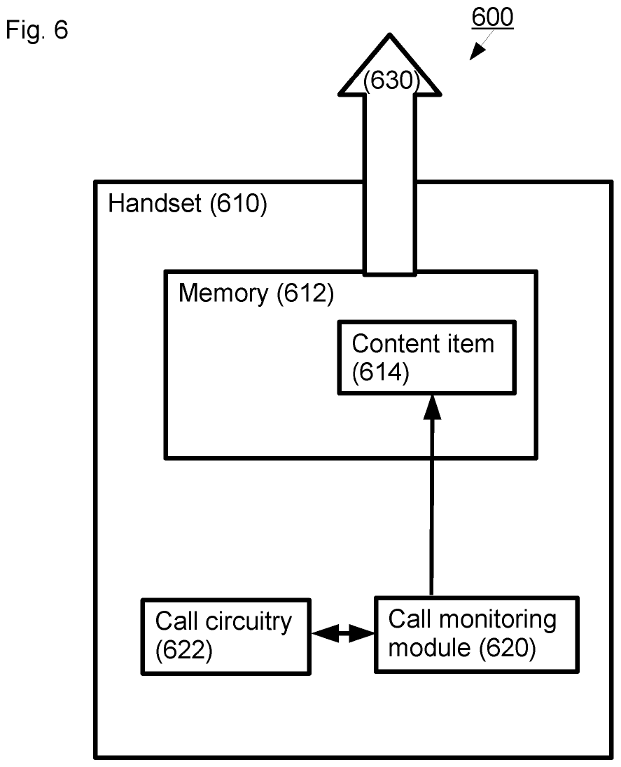

FIG. 6 is a schematic diagram of a system for pushing ring tone content according to some exemplary embodiments of the invention indicated generally as 600.

Depicted exemplary system 600 includes a telephone handset 610 storing at least one content item 614 in a memory 612 and a call monitoring module 620 that detects an outgoing call in call circuitry 622. Upon detection of an outgoing call, call monitoring module 620 sends at least one of the at least one content items to the number being called via a data connection.

In some embodiments the at least one content item 614 is stored as a pointer to a remote memory location. Remote memory locations include servers and/or cloud storage devices. Alternatively or additionally, in some embodiments the at least one content item 614 is formatted as a ringtone. Ringtone as used here includes audio and/or video data formatted for presentation in response to an incoming call.

First Exemplary Method

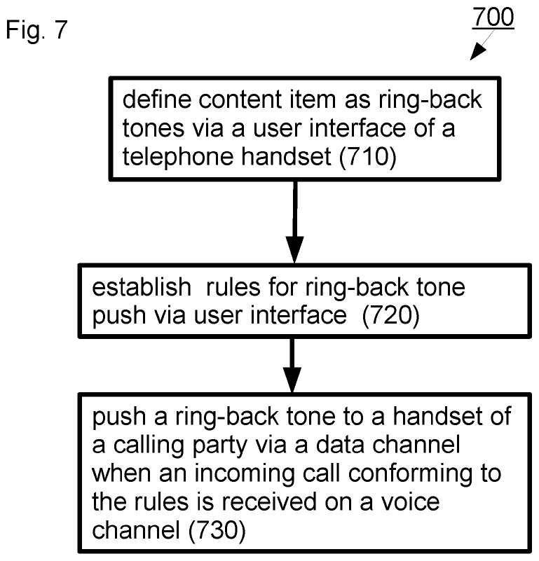

FIG. 7 is a simplified flow diagram of a method for pushing ring-back tones according to some exemplary embodiments of the invention indicated generally as 700.

Depicted exemplary method 700 includes defining 710 one or more content items as ring-back tones via a user interface of a telephone handset.

Depicted exemplary method 700 also includes establishing 720 rules for ring-back tone push via the user interface and pushing 730 the ring-back tone to a handset of a calling party via a data channel when an incoming call is received on a voice channel.

In some embodiments at least some of the one or more content items includes visual information.

Second Exemplary Method

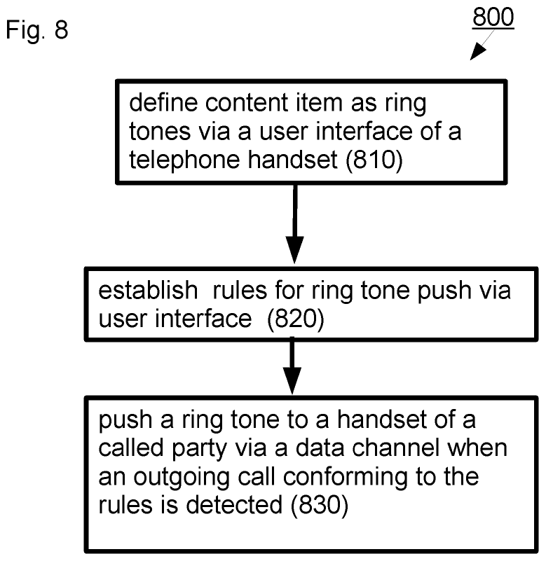

FIG. 8 is a simplified flow diagram of a method for pushing a ring tone according to some exemplary embodiments of the invention indicated generally as 800.

Depicted exemplary method 800 includes defining 810 one or more content items as ring tones via a user interface of a telephone handset.

Depicted exemplary method 800 also includes establishing 820 rules for ring tone push via said user interface and pushing 830 the ring tone to a handset of a called party via a data channel when an outgoing call conforming to the rules is made.

In some embodiments at least some of the one or more content items includes visual information.

Exemplary Content Item Types

According to various exemplary embodiments of the invention the content items uploaded and downloaded in the various systems and methods described hereinabove include audio and/or video and/or graphics.

It is expected that during the life of this patent many content file formats will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are illustrative in nature and do not limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Specifically, the invention has been described in the context of targeted distribution among people that call one another but might also be used in conjunction with super distribution strategies.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A system comprising:
(a) a server receiving a calling party's phone number and a called party's phone number when a telephone call is placed;
(b) a database of content items uploaded to the server, each of said content items associated with a telephone number of a party that uploaded it; and
(c) a content delivery mechanism configured to push a unique identifier (UID) of a specific content item uploaded by the called party to the calling party's handset in response to said receiving by said server.

2. A system according to claim 1, wherein said content delivery mechanism resides on said server.

3. A system according to claim 1, wherein said server is not operated by a service provider handling said telephone call which is placed.

4. A system according to claim 1, wherein said database resides in a cloud server

5. A system according to claim 1, wherein said content delivery mechanism pushes an applet to the calling party's handset, said applet causing automatic download and presentation of said specific content item.

6. A system according to claim 1, wherein an elapsed time between placement of said call by said calling party and onset of presentation of said specific content item on said calling party's handset is less than 2 seconds.

7. A system comprising:
(a) a server receiving requests to deliver a specific content item to a calling party's handset, each request originating from a handset of a called party;
(b) a database of content items uploaded to the server, each of said content items associated with a telephone number of a party that uploaded it; and
(c) a content delivery mechanism configured to push a unique identifier (UID) of a specific content item from said server to the calling party's handset in response to said request originating from a handset of a called party.

8. A system according to claim 7, comprising:
(d) a rules engine governing distribution of content items in said database according to predetermined rules.

9. A system according to claim 7, wherein said predetermined rules are provided as part of each of said content items uploaded to said server.

10. A system according to claim 7, wherein said predetermined rules are provided as part the content delivery mechanism.

11. A system according to claim 8, comprising:
a profile database of people associated with specific phone numbers, wherein data from said profiles is available to said rules engine.

12. A system according to claim 7, wherein said server is not operated by a service provider handling telephone calls.

13. A system according to claim 7, wherein said database resides in a cloud server

14. A system comprising:
(a) a database of content items uploaded to a server, each of said content items associated with a telephone number of a party that uploaded it; and
(b) a distribution mechanism that distributes each of said content items associated with a telephone number of a party that uploaded it to a plurality of handsets belonging to other parties.

15. A system according to claim 14, comprising:
(c) a rules engine governing distribution of content items by said distribution mechanism according to predetermined rules.

16. A system according to claim 14, wherein said predetermined rules are provided as part of each of said content items uploaded to said server.

17. A system according to claim 14, comprising a profile database of people associated with specific phone numbers, wherein data from said profiles is available to said rules engine.

18. A system according to claim 14, comprising:
a content locking module configured to lock each of said content items associated with a telephone number of a party that uploaded it item so the locked content item is accessible only in response to an incoming call from a telephone number of a party that uploaded it.

19-28. (canceled)
